(19) United States
(12) Patent Application Publication
(10) Pub. No.: US 2006/0047423 A1
(43) Pub. Date: Mar. 2, 2006

(54) Navigation system and method for detecting deviation of mobile objects from route using same

(75) Inventor: Hyun-Suk Min, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/189,535

(22) Filed: Jul. 26, 2005

(30) Foreign Application Priority Data
Aug. 31, 2004 (KR) P2004-69188

(51) Int. Cl. G01C 21/34

(52) U.S. Cl. 701/209; 701/202; 340/995.19

(57) ABSTRACT

Disclosed is a navigation system that converts route guidance information into network data and determines the deviation of a mobile object from a route using a map-matching probability that shows a degree of match between a current location and network data.

### PRIORITY

This application claims priority to an application entitled “Navigation System and Method for Detecting Deviation of Mobile Objects from Route Using Same” filed with the Korean Intellectual Property Office on Aug. 31, 2004 and assigned Serial No. 2004-69188, the contents of which are hereby incorporated by reference.

### BACKGROUND OF THE INVENTION

1. Field of the Invention

The present invention relates to a navigation system, and more particularly to an off-board navigation system for detecting the deviation of a mobile object such as a car from a predetermined travel route.

2. Description of the Related Art

Typically, car navigation systems provide drivers with various helpful information such as current location, optimal routes to chosen destinations and dynamic route guidance.

The most basic function of car navigation systems is to accurately determine the current location of a car. The car navigation systems generally use a GPS (Global Positioning System) and DR (Dead Reckoning) to trace the location of a mobile object. GPS is a worldwide navigation and positioning system which determines the location of an object on earth using 24 GPS satellites orbiting the earth at an altitude of approximately 20,183 km. GPS is a satellite navigation system in which a GPS receiver installed on an observational station receives a radio wave transmitted from a satellite, the accurate location of which is known, and calculates the time taken for the radio wave to reach the site from the satellite to determine the location of the observational station. Accordingly, the car navigation systems using a GPS sensor can provide positional information based on geometric coordinates x, y, z, and current time information t of a mobile object such as a car.

DR is a method of navigation for detecting the current location and traveling direction of a car using an internal inertia sensor. The inertia sensor (DR sensor) can be classified into a sensor for measuring a distance traversed (for example, a speedometer, a mileometer or an accelerometer) and a sensor for measuring a turning angle (for example, a geomagnetic sensor or a gyro).

However, the GPS sensor may have errors such as ionospheric delay, a satellite clock error and a multi-path error. In addition, the DR sensor may have errors such as an initial alignment error and a conversion factor error and has a tendency to accumulate the errors, thereby lowering the accuracy of location determination. Particularly, when a car passes downtown areas surrounded by high-rise buildings, trees or tunnels, the errors become larger and accumulate because the GPS signal cannot be sufficiently received. Thus, when the location information of a car measured using the GPS and DR sensors is indicated on a map, it does not agree with the actual location of the car.

In order to solve this problem, general navigation systems calculate the position and attitude angle of the car using a GPS/DR integrated filter and measure the precise current location of the car using the calculated position and attitude angle. After performing a map-matching using the measured current location and road map data (i.e., a digital map), the navigation systems trace the location of the moving car on the map and guide the user along a recommended route.

The overall navigation systems are divided into on-board and off-board navigation systems. On-board navigation systems calculate an optimal route using their own digital map for the route guidance, whereas off-board navigation systems receive optimal route data from an external server having a digital map.

FIG. 1 is a schematic block diagram of a conventional off-board navigation system. Referring to FIG. 1, a server 20 storing a digital map generates information about complicated calculation and guidance of a route and sends the generated information to a terminal 10 upon the request of the terminal 10 or under a predetermined operation condition.

The terminal 10 of the navigation system includes a sensor with a GPS sensor 11 and a DR sensor 12, a filter 13, a server data receiver 14, a traveling path tracer 15, a deviation detector 16 and a route guidance unit 17. The GPS sensor 11 receives GPS signals and detects location information (geometric coordinates x, y and z) and current time information t of a car. The DR sensor 12 is a sensor detecting its own relative location and moving direction based on previous location information. The DR sensor 12 senses a velocity v and a steering angle θ of the car. The filter 13 is a GPS/DR integrated filter that calculates the current location of the car based on the location information x, y, z and time information t received from the GPS sensor 11 and the velocity v and steering angle θ received from the DR sensor 12. The calculated current location includes an error due to the error included in the positioning data inputted to the filter 13 from the GPS sensor 11 and the DR sensor 12.

The server data receiver 14 receives route guidance information generated as a result of a route calculation by the server 20 and transmits the information to the traveling path tracer 15. The traveling path tracer 15 compares the route guidance information received from the server data receiver 14 with the current location information received from the filter 13 to trace the traveling path of the car. The traveling path tracer 15 sends results of the trace to the deviation detector 16 and the route guidance unit 17. Upon receiving the route guidance information from the server data receiver 14 and the traveling route trace results from the traveling path tracer 15, the deviation detector 16 calculates a difference between the location according to the route guidance information and the actual location according to the trace results and determines whether the difference between the two locations exceeds a predetermined distance, thereby detecting deviation from the route. The deviation detector 16 transfers the deviation detection results to the route guidance unit 17. Based on the traveling path trace results received from the traveling path tracer 15 and the deviation detection results received from the deviation detector 16, the route guidance unit 17 informs the user of the optimal route and any deviation from the route.

FIG. 2 illustrates a process of detecting the deviation from a route in a conventional navigation system. FIG. 2 shows a route from a starting point A to a destination point B. When the driver wishes to travel from point A to point B, the server 20 provides the terminal 10 with information about an optimal route to point B. Then the terminal 10 determines whether the car has deviated from the optimal route, based on the information received from the server 20 and the current location of the car obtained from the GPS sensor and the DR sensor. In other words, the terminal 10 calculates a difference between the current location according to the route guidance information received from the server 20 and that obtained from the GPS sensor and the DR sensor, and determines whether the difference exceeds a predetermined distance to detect deviation from the optimal route.

In FIG. 2, P is a point from which the car traveling toward point B from point A according to the route guidance information received by the terminal 10 begins to deviate from the route. Pa is a point included in the optimal route. Pb is a current location of the car detected by the GPS sensor and the DR sensor. The terminal 10 calculates a distance D between Pa and Pb and determines whether the calculated distance D is greater than a predetermined distance. If the calculated distance D is greater than the predetermined one, the terminal 10 will recognize that the car has deviated from the optimal route. On the other hand, if the calculated distance D is within the predetermined one, the terminal will recognize that the car normally travels along the optimal route.

The terminal 10 can detect the deviation from the route only when the distance D between a point Pa on the optimal route and the current location Pb detected by the sensors is greater than the predetermined distance. In other words, the terminal 10 cannot detect the deviation from the route until and unless the distance D becomes greater than the predetermined one. The terminal 10 cannot determine whether the car has deviated from the optimal route from the time the car begins to deviate until the car deviates by the predetermined distance. It is possible to more rapidly detect the deviation from the route by reducing the predetermined distance. In such a case, however, the range of predetermined distance may overlap the error range of current location, which makes it difficult to exactly detect the deviation. In addition, if a first deviation is not promptly detected because the distance D between Pa on the optimal route and current location Pb of the car is within the predetermined distance, a second deviation will likely occur in succession, making it more difficult for the navigation system to perform the route guidance.

### SUMMARY OF THE INVENTION

Accordingly, the present invention has been made to solve the above-mentioned problems occurring in the prior art, and an object of the present invention is to provide a navigation system and method for rapidly and exactly detecting the deviation of a car from a route.

Another object of the present invention is to provide a navigation system and method for rapidly and exactly detecting the deviation of a car from a route using map-matching information and network information, instead of using a difference between a location according to route guidance information provided from a server and an actual location of the car detected by a traveling path trace.

In order to accomplish the above objects of the present invention, there is provided a navigation system including: a server for calculating an optimal route using a digital map and providing route guidance information including linear position information of the calculated optimal route; and a terminal for converting the route guidance information received from the server into network data, matching current location data obtained through a sensor with the network data and determining whether a car has deviated from the optimal route based on a map-matching probability representing a degree of match between locations according to the current location data and the network data.

In accordance with another aspect of the present invention, there is provided a method for detecting the deviation of a mobile object from a route in a navigation system, which includes the steps of: receiving route guidance information including linear position information of an optimal route from a server; converting the linear position information included in the route guidance information into network data; matching a current location of the mobile object on a digital map based on current location data obtained through a sensor and the network data; generating map-matching data including a map-matching probability representing a degree of match between the current location of the mobile object and an optimal location on the digital map; and determining whether the mobile object has deviated from the optimal route based on the map-matching data.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic block diagram of a conventional navigation system;

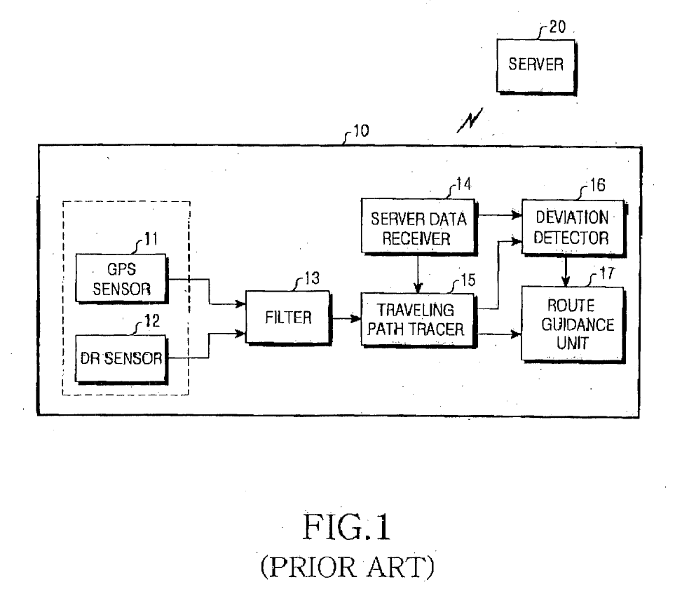

FIG. 2 is a view illustrating a process of detecting the deviation from a route in a conventional navigation system;

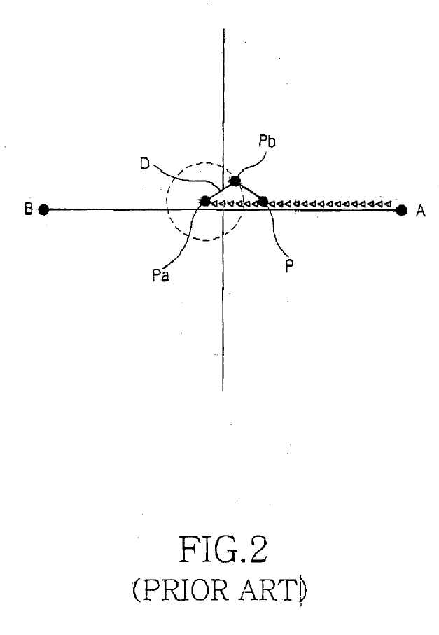

FIG. 3 is a block diagram of a server of a navigation system according to the present invention;

FIG. 4 is a block diagram of a terminal of a navigation system according to the present invention;

FIG. 5 is a linear position information table of an optimal route received from a server according to the present invention;

FIG. 6 is a table of network data converted from linear position information according to the present invention; and

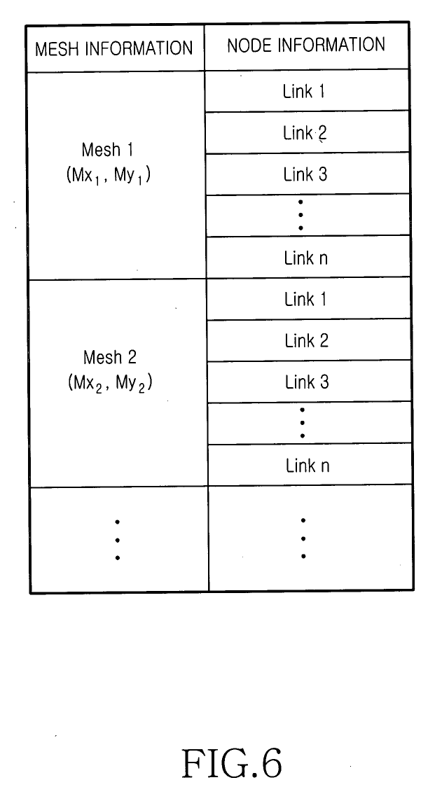

FIG. 7 is a flow chart illustrating a process of detecting the deviation from a route in a navigation system according to the present invention.

### DETAILED DESCRIPTION OF THE PREFERRED EMBODIMENT

Hereinafter, a preferred embodiment of the present invention will be described with reference to the accompanying drawings. In the drawings, the same element, although depicted in different drawings, will be designated by the same reference numeral or character. Although certain elements, such as a circuit device, are specifically defined in the following description of the present invention, it will be obvious to those skilled in the art that such definitions of elements are merely to improve understanding of the present invention and that the present invention can be carried out without such specific elements. Also, in the following description of the present invention, a detailed description of known functions and configurations incorporated herein will be omitted when it may make the subject matter of the present invention unclear.

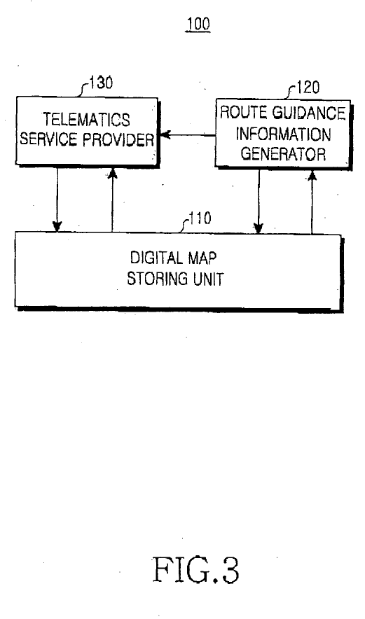

FIG. 3 is a block diagram of a server 100 of a navigation system according to the present invention. The server 100 provides route guidance information (such as, an optimal route to a specified destination and POI (points of interest)) using a digital map upon a request from a terminal 200. As shown in FIG. 3, the server 100 includes a digital map storing unit 110, a route guidance information generator 120 and a telematics service provider 130.

The digital map storing unit 110 stores a digital map having such information as nodes, links, meshes and display information.

The route guidance information generator 120 generates route guidance information including optimal route information and guidance information as requested by the terminal 200, using the mesh, link and node information in the digital map stored in the digital map storing unit 110. The optimal route information is linear position information corresponding to an optimal route to travel from a starting point to a destination. The guidance information is a guide to the optimal route from the starting point to the destination.

The telematics service provider 130 generates telematics service data using the digital map stored in the digital map storing unit 110. The telematics service provider 130 serves as an interface for sending or receiving data concerning the current location of a moving car and a specified destination. It sends route guidance information generated from the route guidance information generator 120 to the terminal 200 through a communication network.

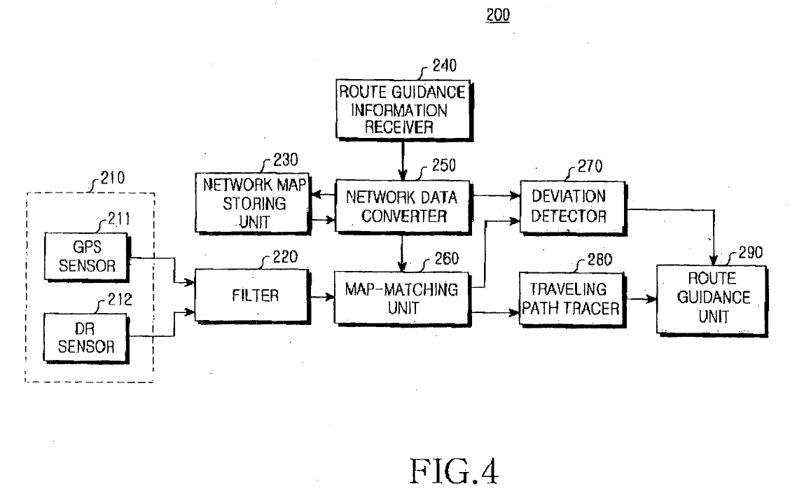

FIG. 4 is a schematic block diagram of the terminal 200 of the navigation system according to the present invention. The terminal 200 detects the current location of a car, converts the optimal route information included in the route guidance information provided from the server 100 into network data, matches the detected current location with the network data to obtain a matching probability and determines whether the car has deviated from the optimal route based on the matching probability. Referring to FIG. 4, the terminal 200 includes a sensor 210, a filter 220, a network map storing unit 230, a route guidance information receiver 240, a network data converter 250, a map-matching unit 260, a deviation detector 270, a traveling path tracer 280 and a route guidance unit 290.

The sensor 210 for measuring the current location of the car comprises a GPS sensor 211 and a DR sensor 212. The GPS sensor 211 receives GPS signals and detects location information (geometric coordinates x, y and z) and current time information t of the car using the GPS signals. The DR sensor 212 is a sensor detecting its own relative location and moving direction based on previous location information. The DR sensor 212 senses a velocity v and a steering angle θ of the car.

The filter 220 filters the location information input from the sensor 210 to calculate the current location. In other words, the filter 220 receives the location information x, y, z and time information t of the car from the GPS sensor 211 and the velocity v and steering angle θ from the DR sensor 212 and then calculates the current location of the car based on the received information.

The network map storing unit 230 stores a network digital map made up of network data such as mesh numbers, link numbers and node numbers.

The route guidance information receiver 240 receives route guidance information including optimal route information and guidance information from the server 100. The optimal route information provided from the server 100 is linear position information showing an optimal route to travel from a starting point to a destination.

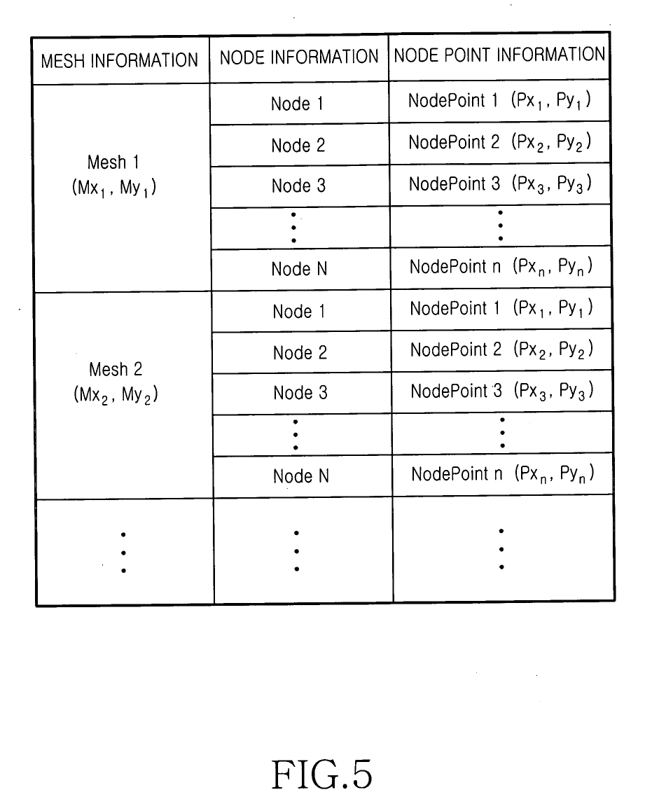

FIG. 5 is a linear position information table of an optimal route received from the server 100 according to the present invention. Referring to FIG. 5, the digital map of the server 100 is divided into meshes of a predetermined size, each (Mesh 1 to Mesh n) having mesh information representing its own position. For example, Mesh 1 can have mesh information represented by coordinate (Mx₁, My₁), while Mesh 2 can have mesh information represented by coordinate (Mx₂, My₂). Each mesh includes a plurality of nodes (Node 1 to Node n) representing particular cities or regions. Each node includes a plurality of node points (Node Point 1 to Node Point n) representing particular points in the node. Each node point (Node Point 1 to Node Point n) has node point information that shows its own position. For example, Node Point 1 can have node point information represented by (Px₁, Py₁), while Node Point 2 can have node point information represented by (Px₂, Py₂).

The digital map of the server 100 has various information about an entire map. The linear position information provided from the server 100 to the terminal 200 includes mesh, node and node point information corresponding to the optimal route to a specified destination.

The map-matching unit 260 performs map-matching using the current location data calculated by the filter 220 and the network data converted from the route guidance information by the network data converter 250. To be specific, the map-matching unit 260 matches the calculated current location of the car on the digital map using the current location data and the network data. Also, the map-matching unit 260 generates map-matching data including a map-matching probability showing a degree of matching between the current location according to the current location data and that according the network data, mesh information, node point information, steering angle information and link information of the location matched. The map-matching unit 260 transfers the generated map-matching data to the deviation detector 270.

The traveling path tracer 280 traces the traveling path of the car using the map-matching data received from the map-matching unit 260. The traveling path tracer 270 transfers results of trace to the route guidance unit 290.

The deviation detector 270 determines whether the car has deviated from the optimal route, using the network data received from the network data converter 250 and the map-matching data received from the map-matching unit 260. To be specific, the deviation detector 270 first determines whether the map-matching probability included in the map-matching data is greater than a predetermined value. If the map-matching probability is not greater than the predetermined one, the deviation detector 270 will defer a deviation determination. On the other hand, if the map-matching probability is greater than the predetermined one, the deviation detector 270 will then determine whether the mesh information included in the map-matching data is identical to that included in the network data.

If the mesh information included in the map-matching data is not identical to that included in the network data, the deviation detector 270 will recognize that the car has deviated from the optimal route. If the mesh information in the map-matching data is identical to that included in the network data, the deviation detector 270 will then determine whether the link information included in the map-matching data is identical to that included in the network data. If the information of the two links are not identical, the deviation detector 270 will recognize that the car has deviated from the route. If the information of the two links are identical, the deviation detector 270 will recognize that the car normally travels along the optimal route according to the route guidance information. Upon detecting a deviation from the route, the deviation detector 270 sends deviation information to the route guidance unit 290.

Based on the traveling path trace results received from the traveling path tracer 280 and the deviation information received from the deviation detector 270, the route guidance unit 290 informs the user of the optimal route and any deviation from the route.

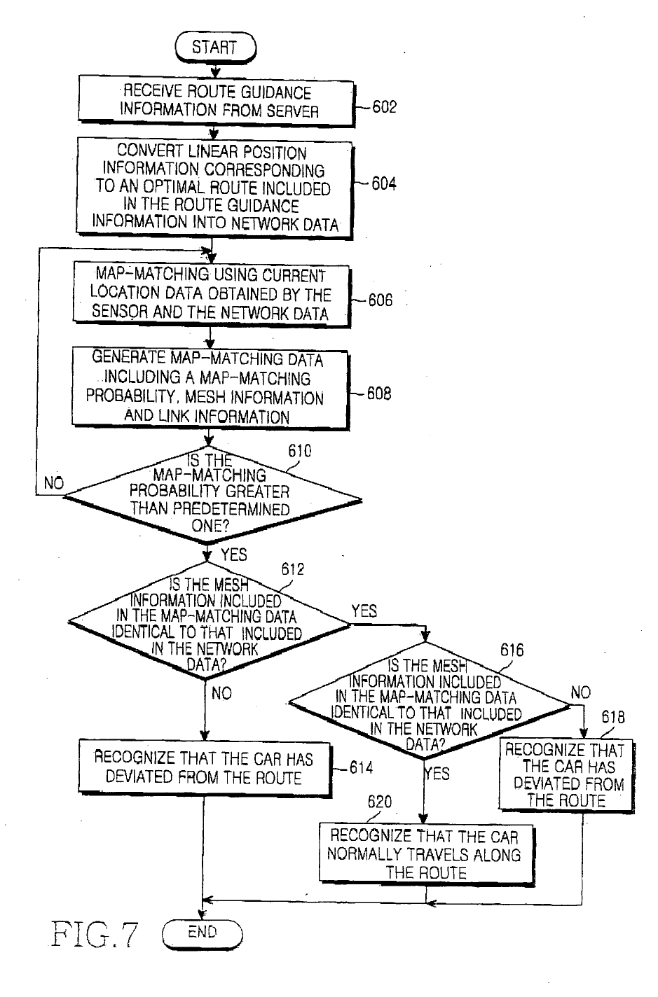

FIG. 7 is a flow chart illustrating the process of detecting a deviation from a route in the navigation system according to the present invention.

Referring to FIG. 7, the terminal 200 of the navigation system receives route guidance information from the server 100 through the route guidance information receiver 240 at step 602. As shown in FIG. 5, the received route guidance information includes linear position information showing an optimal route to a destination from a starting point. At step 604, the terminal 200 converts the linear position information included in the route guidance information into network data at the network data converter 250. To be specific, the terminal 200 converts the linear position information corresponding to the optimal route (i.e., mesh, node and node point information (Mx, My, Px, Py)) into network data (i.e., mesh and link information (Mx, My, link number)).

At step 606, the terminal 200 performs map-matching that matches the current location of the car on the digital map using the current location data obtained by the sensor 210 and the network data converted from the linear position information. Subsequently, at step 608, the terminal generates map-matching data including a map-matching probability showing a degree of matching between the current location according to the current location data and that according to the network data, mesh information, node point information, steering angle information and link information of the location matched. The map-matching data can be represented by:
Map-matching data=(90%, Mx′, My′, Px′, Py′, steering angle, link number)

At step 610, the deviation detector 270 of the terminal 200 determines whether the map-matching probability included in the map-matching data is greater than a predetermined value. If the map-matching probability is not greater than the predetermined one (for example, 90%), the terminal 200 will defer a deviation determination and will return to step 606. On the other hand, if the map-matching probability is greater than the predetermined one, the terminal 200 will proceed with step 612 to determine whether the mesh information (Mx′, My′) included in the map-matching data is identical to that (Mx, My) included in the network data. If the mesh information included in the map-matching data is not identical to that included in the network data, the terminal 200 will recognize that the car has deviated from the optimal route at step 614. If the mesh information in the map-matching data is identical to that included in the network data, the terminal 200 will then proceed with step 616 to determine whether the link information (link number) included in the map-matching data is identical to that included in the network data. If the information of the two links are not identical, the terminal 200 will recognize that the car has deviated from the route at step 618. If the information of the two links are identical, the terminal 200 will recognize that the car normally travels along the optimal route according to the route guidance information at step 620.

As explained above, the navigation system according to the present invention uses a map-matching probability that shows a degree of match between the current location of a car with network data converted from route guidance information, without using a distance between the location according to the route guidance information and the actual location of the car detected by a sensor. Accordingly, the navigation system can more rapidly detect a deviation from an optimal route.

In addition, when the current location data obtained through the sensor has lower accuracy (lower map-matching probability) due to various environmental factors, the navigation system defers the deviation determination, thereby preventing an erroneous determination of deviation resulting from inaccurate current location data. The system rapidly detects an initial deviation and prevents any subsequent deviation that may follow the initial deviation.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A navigation system comprising:
a server for calculating an optimal route using a digital map and providing route guidance information including linear position information of the calculated optimal route; and
a terminal for converting the route guidance into network data, matching current location data obtained through a sensor with the network data and determining whether a mobile object has deviated from the optimal route based on a map-matching probability representing a degree of match between the current location data and the network data.

2. The navigation system as claimed in claim 1, wherein said server includes:
a digital map storing section for storing a digital map having data about an entire map;
a route guidance information generator for generating route guidance information including linear position information of an optimal route using the digital map; and
a telematics service provider for sending the generated route guidance information to the terminal.

3. The navigation system as claimed in claim 1, wherein said linear position information of the optimal route includes mesh information about meshes, the meshes representing territories of a predetermined area divided on the digital map, node information about nodes representing cities or regions in each mesh, and node point information about node points representing points or spots in each node.

4. The navigation system as claimed in claim 2, wherein said linear position information of the optimal route includes mesh information bout meshes, the meshes representing territories of a predetermined area divided on the digital map, node information about nodes representing cities or regions in each mesh, and node point information about node points representing points or spots in each node.

5. The navigation system as claimed in claim 1, wherein said terminal includes:
a route guidance information receiver for receiving route guidance information including linear position information of an optimal route from the server;
a sensor for measuring a current location of a mobile object;
a filter for filtering the measured location data to calculate current location data of the mobile object;
a network map storing section for storing a network map made up of network data of a map;
a network data converter for converting the linear position information of the optimal route into network data using the network map;
a map-matching section for performing a map-matching using the calculated current location data and the network data and generating map-matching data including a map-matching probability, mesh information and link information of the matched location according the map-matching results; and
a deviation detector for detecting the deviation of the mobile object from the optimal route based on the map-matching.

6. The navigation system as claimed in claim 5, wherein said deviation detector recognizes that the mobile object has deviated from the optimal route, when the map-matching probability included in the map-matching data is greater than a predetermined value and the mesh information included in the map-matching data is not identical to that included in the network data.

7. The navigation system as claimed in claim 5, wherein said deviation detector recognizes that the mobile object has deviated from the optimal route, when the map-matching probability included in the map-matching data is greater than a predetermined value and the link information included in the map-matching data is not identical to that included in the network data.

8. The navigation system as claimed in claim 6, wherein said deviation detector recognizes that the mobile object normally travels along the optimal route, when the map-matching probability included in the map-matching data is greater than a predetermined value and the mesh information and link information included in the map-matching data are identical to those included in the network data.

9. The navigation system as claimed in claim 7, wherein said diviation detector recognizes that the mobile object normally travels along the optimal route, when the map-matching probability included in the map-matching data is greater than a predetermined value and the mesh information and link information included in the map-matching data are identical to those included in the network data.

10. The navigation system as claimed in claim 6, wherein said deviation detector defers a deviation determination when the map-matching probability included in the map-matching data is not greater than a predetermined value.

11. The navigation system as claimed in claim 7, wherein said deviation detector defers a deviation determination when the map-matching probability included in the map-matching data is not greater than a predetermined value.

12. A method for detecting the deviation of a mobile object from a route in a navigation system, which comprises the steps of:
receiving route guidance information including linear position information of an optimal route from a server;
converting the linear position information into network data;
matching a current location of the mobile object on a digital map based on current location data obtained through a sensor with the network data;
generating map-matching data including a map-matching probability representing a degree of match between the current location of the mobile object and an optimal location on the digital map; and
determining whether the mobile object has deviated from the optimal route based on the map-matching data.

13. The method as claimed in claim 12, wherein said map-matching data further includes mesh information and link information of the matched location.

14. The method as claimed in claim 12, wherein said step of determining the deviation of the mobile terminal from the optimal route based on the map-matching data includes:
determining whether the map-matching probability is greater than a predetermined value; and
deferring a deviation determination when the map-matching probability is not greater than the predetermined value, or determines the deviation of the mobile object from the optimal route using the mesh information included in the map-matching data when the map-matching probability is greater than the predetermined value.

15. The method as claimed in claim 14, wherein said determination of the deviation using the mesh information included in the map-matching data includes:
determining whether the mesh information included in the map-matching data is identical to that included in the network data; and
recognizing that the mobile object has deviated from the optimal route when the mesh information included in the map-matching data is not identical to that included in the network data.

16. The method as claimed in claim 15, further including:
determining whether the link information included in the map-matching data is identical to that included in the network data; and
recognizing that the mobile object has deviated from the optimal route when the link information included in the map-matching data is not identical to that included in the network data, or recognizing that the mobile object normally travels along the optimal route when the link information included in the map-matching data is identical to that included in the network data.
